(19) United States
(12) Patent Application Publication
(10) Pub. No.: US 2013/0210160 A1
(43) Pub. Date: Aug. 15, 2013

(54) METHOD AND DEVICE FOR DETECTING HYDROGEN

(71) Applicants: Frank Roessner, Oldenburg (DE); Stefan Schoenen, Jaderberg (DE)

(72) Inventors: Frank Roessner, Oldenburg (DE); Stefan Schoenen, Jaderberg (DE)

(73) Assignee: Carl Von Ossietzky Universitaet Oldenburg, Oldenburg (DE)

(21) Appl. No.: 13/643,253

(22) PCT Filed: Apr. 26, 2011
(86) PCT No.: PCT/EP2011/056530

§ 371 Date: Jan. 7, 2013

(30) Foreign Application Priority Data
Apr. 26, 2010 (DE) 10 2010 028 211.1

(51) Int. Cl. G01N 30/68

(52) U.S. Cl. CPC G01N 30/68
USPC 436/144; 422/54

(57) ABSTRACT

The invention relates to a device and to a method for the detection of hydrogen in a gas mixture, wherein the device comprises a catalyst unit which is connected to a source and a supply device for CO and/or CO₂, respectively, or comprises these and wherein the catalyst unit is connected to a flame ionization detector by a feed line, such that the gas mixture, especially containing an inert carrier gas after passing through the catalyst unit is conducted to the FID. The FID is operated with hydrogen as fuel gas.

The present invention relates to a method and to a device for use in the method for the detection of hydrogen in a gas mixture, especially for continuous quantitative detection of hydrogen in a gas mixture.

According to the invention it is provided to detect hydrogen in a gas mixture, especially in mixture with a carrier gas which for example consists of inert gases, by a flame ionization detector (FID).

### STATE OF THE ART

In the gas-chromatography the content of hydrogen is determined exclusively using a thermal-conductivity cell detector, whereas a flame ionization detector (FID) does not produce a signal for hydrogen in the carrier gas, and furthermore hydrogen is used as fuel for the flame.

WO 02/090960 for detection of hydrogen in nitrogen as carrier gas describes the use of the ion mobility spectrometry in which the gas is ionized by radioactive irradiation in order to obtain ions the time of flight of which is measured in an electric field.

For the detection of CO and CO₂ by means of gas-chromatography it is known to carry out a catalytic reduction before the FID using a metal-containing catalyst by addition of hydrogen for the detection CO and CO₂ in order to reduce CO and CO₂ to methane, respectively, which is subsequently detectable in the FID.

### OBJECT OF THE INVENTION

It is the object of the invention to provide a device and a method which can be carried out therewith by which hydrogen is detectable in an alternative way at a high sensitivity and preferably using a simple device, especially in the gas-chromatography or in the temperature-programmed reduction of metal oxide.

### GENERAL DESCRIPTION OF THE INVENTION

The invention achieves the object by the features of the claims and especially by means of a device and by a method for the detection of hydrogen in a gas mixture, wherein the device comprises a catalyst unit which is connected to or comprises a source and a supply system for CO and/or CO₂, respectively, and wherein the catalyst unit is connected to a flame ionization detector (FID) by a feed line, such that the gas mixture, especially containing an inert carrier gas after passing through the catalyst unit is conducted to the FID. The FID is operated with hydrogen as fuel gas. The method according to the invention which e.g. can be a method for measurement of hydrogen in a gas mixture, for gas-chromatography or for catalyst characterization, is distinguished by the conversion of hydrogen to methane which subsequently is detected by flame ionization detection.

According to the invention, the catalyst unit of the detection device for hydrogen is connected to an FID by a feed line, wherein at the inlet of the catalyst unit for the gas mixture which is to be analysed an injection device for a gas mixture is connected, e.g. a sample loop which is accessible through an injection valve, and wherein optionally a separation column for gas-chromatography is arranged between the injection device and the inlet of the catalyst device. Preferably, a source for inert cattier gas is connected to the injection device which source provides carrier gas for transport of the gas mixture into the catalyst unit and into the subsequent FID.

In a preferred embodiment, this detection device for hydrogen in a gas mixture is connected to a reactor by a duct, which reactor is streamed through by hydrogen-containing gas, wherein the gas exiting the reactor is guided at least partially through the duct to the detection device. Such a reactor preferably is heatable and suitable for the controlled reduction of catalyst precursors having a content of oxidized metal, as by means of such a device the consumption of hydrogen, which is caused by the reduction of the metal oxide, can easily be detected quantitatively. Correspondingly, the invention also relates to a method for catalyst production using the method of the temperature-programmed reduction in which hydrogen in the gas mixture which is removed from the reactor in which a metal oxide is reduced forms the initial gas mixture which is conducted into a reaction unit for the preferably continuous conversion with CO and/or CO₂. The gas mixture produced in the reaction unit by conversion of the hydrogen-containing initial gas mixture with added CO or CO₂ is conducted to an FID by a feed line and is detected using the FID, wherein the FID is operated with hydrogen-containing gas.

The advantage of the method according to the invention which can be earned out using the device lies in the use of the FID as detection unit for the hydrogen of all initial gas mixture, as in the duct carrying the gas mixture to the FID a reaction unit is arranged which is connected to a supply unit for CO and/or CO₂, and continuously added CO and/or CO₂ for continuous generation of methane is generated from the hydrogen of the initial gas mixture which is to be analysed. By means of the preferable continuous conversion of the hydrogen of the initial gas mixture, which is to be analysed, to methane, the high sensitivity of an FID can be used which is considerably higher than that of a thermal-conductivity cell detector (TCD) which is conventionally used for the detection and provides a considerably simpler detection device than for example an ion mobility spectrometer. As the conversion of the hydrogen of the initial gas mixture in the reaction unit occurs continuously and quantitatively, this step of the method does not impair the detection of hydrogen in a continuous flow of gas and can also be used in gas-chromatography. As the FID does not generate a signal for CO or CO₂, CO or CO₂ can be fed into the reaction unit optionally continuously and in excess.

The device according to the invention and the method for detection of hydrogen, e.g. in a method for catalyst characterization, allow a very high resolution of the detection of hydrogen in a flow of gas to be analysed and in a gas mixture to be analysed, respectively, such that the device preferably is connected to the outlet duct of a reactor in which a reaction can proceed which consumes added hydrogen, preferably continuously added hydrogen, or produces hydrogen. Particularly preferred, the detection device is connected to an outlet duct of a reactor which is charged with a hydrogen-containing gas, and which especially is streamed through continuously by hydrogen-containing gas, wherein the exiting gas mixture is conducted into the catalyst unit by an exiting duct, which catalyst unit is connected to a supply unit for CO and/or CO₂ and has a feed line having an FID connected, such that the hydrogen-containing initial gas mixture after passing through the catalyst unit is conducted to the FID by the feed line and is analysed there on the content of methane, wherein the methane content of the gas mixture was produced completely or partially by conversion of the hydrogen in the gas mixture fed into the catalyst unit with CO and/or CO₂.

The hydrogen which according to the invention is detected using an FID can originate from the degradation of a carbonless hydrogen compound, e.g. by means of catalytic degradation of a carbonless hydrogen compound. Therefore, the device can have an additional second catalyst unit which is arranged in the flow of gas before the catalyst unit which is connected to the supply unit for CO and/or CO₂. Alternatively, the device can be used for analysis of the carbonless hydrogen compound, when the carbonless hydrogen compound is degraded by the catalyst contained in the catalyst unit under formation of hydrogen. Correspondingly, the invention also relates to a method for detection of a carbonless hydrogen compound using an FID operated with hydrogen, wherein the carbonless hydrogen compound is catalytically converted to hydrogen in an additional step prior to the conversion with CO and/or CO₂ in the catalyst unit. In the additional step of conversion of the carbonless hydrogen compound to hydrogen a residual compound is produced, too. Examples for carbonless hydrogen compounds are NH₃, which is catalytically converted to hydrogen and nitrogen, and halogen-hydrogen-compounds, which are catalytically converted to hydrogen and the halogen, as well as hydrazine, hydroxylamine and HCN. Therefore, the method can also be used for detection of one of these compounds, e.g. in a method in which it carbonless hydrogen compound is desorbed from another material, e.g. from a catalyst or from a carrier material of a catalyst. The additional conversion of a carbonless hydrogen compound to hydrogen can occur in an additional second catalyst unit which in the device is arranged in the direction of the gas flow before the catalyst unit connected to the supply unit for CO and/or CO₂ in the flow path or in a section of this catalyst unit, when the carbonless hydrogen compound is degraded under formation of hydrogen under the conditions of the formation of methane from hydrogen and added CO and/or CO₂. The second catalyst unit and the catalyst unit connected to the supply unit for CO and/or CO₂, respectively, can comprise e.g. a nickel catalyst for detection of NH₃, preferably on an oxidic carrier (e.g. magnesium oxide), which preferably is thermostated to maximally 1300° C., e.g. to 700 to 1000° C., more preferred to 800 to 900° C.

The second catalyst unit can be a capillary connected to the inlet of the methane-producing catalyst unit which is filled with a catalyst or which is coated with a catalyst on its inner side. This is because the catalyst of the second catalyst unit in addition to the gas mixture containing the carbonless hydrogen compound does not require a further reactant for generation of hydrogen by decomposition of this hydrogen compound. An example for such a capillary is a capillary coated with nickel on its inner side or filled with porous nickel, which is e.g. of metal, especially stainless steel, quartz or glass.

Due to the high sensitivity of the detection device according to the invention it can generally be used for the detection of hydrogen in a gas mixture, e.g. in the analysis of the hydrogen content of a gas mixture containing hydrocarbons, wherein optionally in a first step the catalyst unit is bypassed in order to detect the methane initially contained in the gas mixture in the FID, and wherein in a second step, which can be carried out chronologically prior to or after the first step, an aliquot of the gas mixture is analysed using the same separation column and additionally the catalyst unit which is connected to the FID by a feed line is streamed through. From the quantitative values for the methane content which are obtainable in this way the hydrogen content of the initial gas mixture can be determined by formation of the difference.

In a device according to the invention without a bypass duct the gas mixture to be analysed can be conducted over a separation column prior to the feeding, into the catalyst unit. Since optionally contained methane and hydrogen of the initial gas mixture are separated by means of the separation column, two differing methane signals are subsequently detected in the FID, one of which indicates the methane initially contained in the sample and the other indicates the initially contained hydrogen which has been converted to methane. Due to the different retention periods, the separation of the initially contained methane from the initial hydrogen allows the allocation of the methane signals detected in the FID to the initial methane and to the initial hydrogen which has been produced by conversion of the initial hydrogen to methane.

The catalyst unit can be arranged e.g. between the injection device arranged at the inlet of the separation column and the inlet of the separation column, or between the separation column and the feed line which is connected to the FID. In these embodiments, the order of the steps of the detection method is arbitrary.

In particular, the detection device according to the invention can find use in a method for reduction of a composition having a content of oxidized metal, for example in a method for reduction of an initial mixture having a content of oxidized metal which can be converted by reduction of the oxidized metal to a catalyst, in which the metal has a lower oxidation number, and e.g. is reduced to elementary metal. Preferably, the detection method according to the invention is therefore used in the temperature-programmed reduction for catalyst characterization, especially in the reduction of oxidized metal in an initial mixture for catalysts, e.g. on a silicate, basis.

### DETAILED DESCRIPTION OF THE INVENTION

The invention is now described in greater detail with reference to the Figures in which schematically

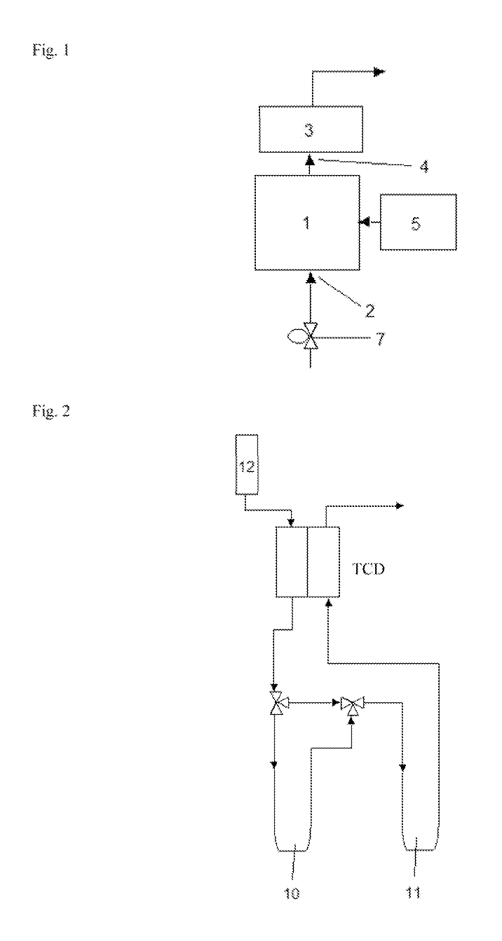

FIG. 1 shows a connection diagram or a device according to the invention,

FIG. 2 shows a conventional apparatus for the temperature-programmed reduction for catalysts,

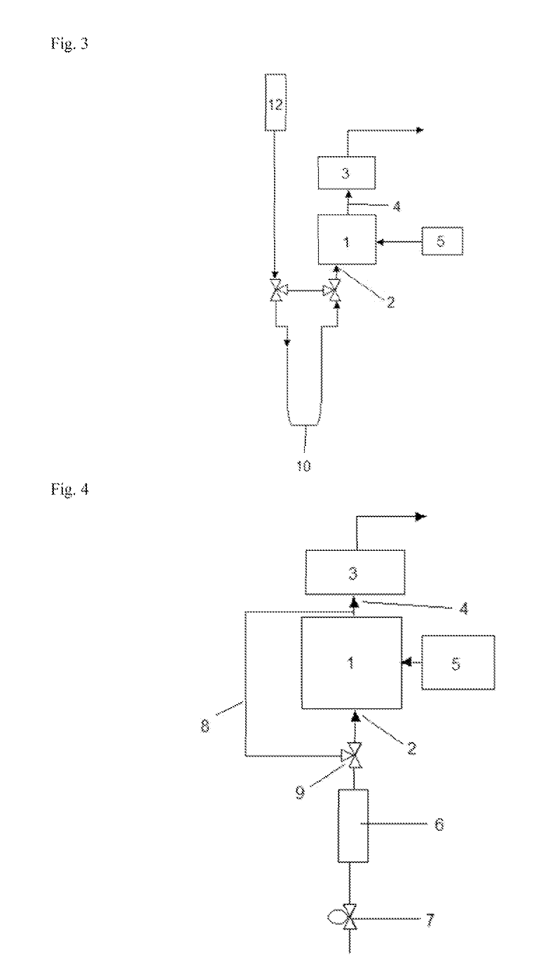

FIG. 3 shows an apparatus according to the invention for the temperature-programmed reduction in the catalyst characterization, and

FIG. 4 shows a further embodiment of a device according to the invention.

As depicted in FIG. 1, the device for detection according to the invention comprises or consists of a catalyst unit 1 comprising an inlet 2 for a hydrogen-containing initial gas mixture and a feed line connected to the FID 3 through which the gas mixture exits from the catalyst unit 1 and is conducted to the FID 3, wherein a supply unit 5 for CO and/or CO₂ is connected to the catalyst unit 1. In a conventional way, the FID 3 has a feed line for fuel gas, especially for a hydrogen-containing inert gas or for hydrogen not depicted), and is provided with an amperometric detection device.

In the detection method using the device according to the invention a hydrogen-containing gas mixture, which is conducted through the inlet 2 into the catalyst unit is converted to methane with CO and CO₂ fed from the supply unit for CO and/or CO₂, respectively, which methane together with the remaining components of the gas mixture fed into the catalyst unit 1 exits from the catalyst unit 1 via the feed line 4 and is conducted to the FID 3 where a detection by means of flame ionization detection occurs.

The method for detection also enables the detection of hydrogen in a continuous method, e.g. by a continuous measurement of a stream of a hydrogen-containing gas mixture, since the conversion of the hydrogen in the gas mixture in the catalyst unit 1 by means of the CO and CO₂ fed from the supply unit 5, respectively, is continuously converted to methane which is conducted to the FID 3 by the feed line 4 and is detected there continuously. As the hydrogen to be analysed in the gas mixture that is led into the catalyst unit 1 is converted to methane at least partially, preferably completely, the FID 3 can be operated with hydrogen and a hydrogen-containing fuel gas, respectively. In the FID 3 a signal is detected which depends on the hydrogen content of the initial gas mixture which was fed into the catalyst unit 1.

The catalyst unit 1 preferably contains a metal-containing catalyst as a catalyst, for example, cobalt and/or nickel, optionally as an unsupported catalyst or on an e.g. oxidic carrier.

FIG. 2 shows a device not according to the invention which is used for example for the temperature-programmed reduction of mixtures containing metal oxides in the characterization of catalysts. The initial mixture for to catalyst to be reduced is arranged in a reactor 10 which is connected to a source 12 for hydrogen-containing inert gas by ducts. As hitherto the detection of hydrogen has been carried out using a thermal-conductivity cell detector (TCD), it was necessary for the quantitative measurement to lead the hydrogen-containing inert gas, which was conducted from the source 12 to the reactor 10, for calibration firstly through a second chamber of the thermal-conductivity cell detector while bypassing the reactor 10, as well as during the reaction in the reactor 10, i.e. after passing through the reactor 10. For the measurement using the thermal-conductivity cell detector, the hydrogen-containing inert gas from the source 12 is to be measured as a reference each time. As in the reduction of metal oxide also water is formed in the reactor 10, for which the thermal-conductivity cell detector is sensitive, it is necessary to freeze out the water by means of a cooling trap 11, which is arranged downstream of the reactor 10, before the reaction gas is fed into the thermal-conductivity cell detector for measurement.

The device according to the invention which schematically is shown in FIG. 3 avoids the use of a cooling trap 11 also in methods for the temperature-programmed reduction of metal oxides, as the detection device according to the invention is insensitive to water, i.e. water generated by the reduction of metal oxides with a hydrogen-containing inert gas from the source 12 is not detected by the FID of the device and therefore can be passed through the catalyst unit 1. Correspondingly, a device for temperature-programmed reduction according to the invention the detection device having a catalyst unit 1 which is connected to a supply unit 5 for CO and/or CO₂ can be provided with an FID 3 connected thereto by a feed line 4, or can consist thereof having a reactor which is arranged upstream which is coupled to a source for hydrogen-containing inert gas, such that the device does not comprise a cooling trap 11.

As the detection device according to the invention has a significantly higher sensitivity than a thermal-conductivity cell detector, for example by the factor 1000, the device is particularly suitable for use as reaction device for the temperature-programmed reduction of metal oxide—containing compositions, as even at very low amounts of metal oxide a precise measurement can be made.

Generally, the catalyst unit 1 is heatable, especially to 200 to 600° C., preferably to 300 to 450° C., in order to allow an efficient conversion of the hydrogen to be measured in the gas mixture to methane with the CO and/or CO₂ continuously fed from the supply unit 5 into the catalyst unit 1.

FIG. 4 shows a further embodiment of the detection device according to the invention. This comprises or consists of a catalyst unit 1 having an inlet 2 for a hydrogen-containing initial gas mixture and a feed line connected to the FID 3 through which feed line the gas mixture exits from the catalyst unit 1 and is conducted to the FID 3, wherein a supply unit 5 for CO and/or CO₂ is connected to the catalyst unit 1. The FID 3 in a conventional way comprises a feed line for fuel gas, especially for a hydrogen-containing inert as or for hydrogen (not depicted) and is provided with an amperometric detection device.

In this embodiment, a separation column 6 is connected to the inlet 2 at the inlet of which separation column an injection device 7, e.g. having a sample loop for a defined volume of a gas mixture, is arranged. The separation column 6 in a conventional way comprises a supply device for carrier gas, e.g. for He (not depicted). An optional bypass 8 can directly connect the separation column to the feed line 4 of the FID 3, in order to conduct the gas mixture directly into the FID in a first step after passing through the separation column 6 while bypassing the catalyst unit 1. A valve 9, which especially is a three-way valve, can be arranged in the connection duct between the separation column 6 and the catalyst unit 1, in order to alternatively close the catalyst unit 1 or the bypass 8 between the separation column 6 and the FID 3.

In the detection method using this device a hydrogen-containing gas mixture is conducted to the separation column 6 via the injection device 7. On this separation column methane which optionally is contained in the mixture to be analysed and hydrogen are separated before they are conducted into the catalyst unit 1 through the inlet 2. In the catalyst unit 1 the hydrogen contained is converted with CO and/or CO₂ fed from the supply unit for CO and/or CO₂, respectively, to methane. This together with the remaining components of the gas mixture exits from the catalyst unit 1 via the feed line 4 and is conducted into the FID 3 where a detection by means of flame ionization detection takes place.

### Example 1

### Detection of Hydrogen in Inert Gas

A flow of gas containing hydrogen in admixture with inert gas (Ar) is detected continuously as an hydrogen-containing initial gas mixture using a device shown in FIG. 1. The initial gas mixture is fed at 2 mL/min into a reaction unit which contains a nickel catalyst and is connected to a CO bottle serving as supply unit for CO. CO is continuously (approximately 0.2 mL/min) fed into the catalyst unit, the nickel catalyst is heated to 380° C.

Alternatively, the device of a reaction unit with a supply unit for CO connected and an FID connected to the catalyst unit by a feed line is connected to a conventional apparatus for gas-chromatography. Upon operation of the apparatus using an inert carrier gas (He) the FID then detects a signal which is proportional to the hydrogen content of a sample, when a hydrogen-containing gas mixture is injected into the sample loop and is transported with the flow of carrier as into the catalyst unit.

The FID is operated with hydrogen and detects a signal which is proportional to the hydrogen content of the initial gas mixture.

For control, the feeding of CO into the reaction unit is interrupted. Then it shows that the FID does not detect a signal for hydrogen.

### Example 2

### Detection of Hydrogen in Admixture with Hydrocarbons

For analysis of the hydrogen content of a hydrocarbon-containing gas mixture, an aliquot of the gas mixture in a first step was introduced into the separation column 6 of a device according to FIG. 1 using the injection device which contained a sample loop. The three-way valve 9 was set to connect the separation column 6 to the bypass 8 such that carrier gas after passing through the separation column 6 directly entered the FID 3. In a second step, the three-way valve was set to connect the separation column 6 to the catalyst unit such that carrier gas after passing through the separation column 6 streamed through the inlet 2 into the catalyst unit 1, and there was continuously converted to methane by the CO and/or CO₂ fed from the supply unit 5. After streaming through the feed line 4 this gas mixture converted in the catalyst unit 1 was detected in the FID 3.

For determination of the hydrogen content in the initial gas mixture, the difference of the methane signal which was determined in the second step to the methane signal which was determined in the first step was calculated.

### Example 3

### Detection of NH₃

A flow of gas containing NH₃ in admixture with inert gas (Ar) is conducted preferably continuously at 2 mL/min through a second catalyst unit having a nickel catalyst at 700° C. which was arranged before the catalyst unit of the device used in example 1. The second catalyst unit produced hydrogen and nitrogen corresponding to the reaction equilibrium at the temperature of the nickel catalyst. The gas mixture conducted from the second catalyst unit was detected preferably continuously as the initial gas mixture using a device shown in FIG. 1. Corresponding to example 1, CO is fed preferably continuously (approximately 0.2 mL/min) into the catalyst unit, the nickel catalyst of which is heated to 380° C.

Alternatively, the device having a reaction unit having a supply unit for CO connected and having an FID connected to the reaction unit by a feed line was connected to a conventional apparatus for gas-chromatography.

Upon operation of the apparatus using an inert carrier gas (He) the FID then detects a signal proportional to the ammonia content of a sample, when an ammonia-containing gas mixture is injected into the sample loop and is firstly transported with the flow of carrier gas into the second catalyst unit and then into the catalyst unit to which a supply unit for CO is connected.

The FID is operated with hydrogen and detects a signal which is proportional to the hydrogen content of the initial gas mixture.

For control, the feeding of CO to the reaction unit is interrupted. Then it shows that the FID does not detect a signal for hydrogen.

### Comparative Example

### Temperature-Programmed Reduction of a Metal Oxide

In a device according to FIG. 2 a zeolite in admixture with a metal oxide is inserted into the reactor and is heated during the sweeping with inert gas (Ar) in order to remove bound water. The duct between the reactor and a cooling trap arranged in the duct to the TCD is heated to avoid uncontrolled condensation of water in the duct. For adjustment of a stationary operating status, the reducing mixture of H₂ in Ar is conducted through a chamber of the TCD and while bypassing the reactor through the cooling trap and through the other chamber of the TCD. Subsequently, the flow of gas of H₂ in Ar is conducted through the reactor and the reactor is heated. The reduction of the metal oxide results in the decrease of the hydrogen content of the gas mixture which exits from the reactor and is measured in the TCD. The decrease of the hydrogen content in the continuous flow of the gas mixture exiting from the reactor is detected as an increase of the signal from the TCD.

### Example 4

### Temperature-Programmed Reduction of a Metal Oxide for Catalyst Characterization

In a device of FIG. 3, which in the same reactor contains zeolite in admixture with a metal oxide as in the comparative example, the catalyst unit containing a nickel catalyst is thermostated to 380° C. and is continuously charged with CO as described in example 1. By means of a feed line the gas mixture exiting from the catalyst unit is fed into an FID which is operated with hydrogen as fuel gas. This device does not contain a cooling trap, as the FID does not detect a signal for water which is generated by the reduction of the metal oxide.

For adjustment of a stationary operating status, the reactor is bypassed and H₂ in Ar is conducted through the catalyst unit and through the FID and it shows that a signal which is dependent on the concentration of the hydrogen in the gas mixture fed into the catalyst unit is detected by the FID.

Upon continuous streaming through of the reactor with H₂ in Ar from the source the reactor is heated starting from room temperature. The decrease of the hydrogen content of the H₂ in Ar by the beginning reduction of the metal oxide in the reactor is measured as a decrease of the signal which is detected by the FID. An effect of the water generated by the reduction of the metal oxide onto the signal detected by the FID is not observed.

It has been found that the sensitivity of the measurement of the hydrogen consumption in the temperature-programmed reduction in the method carried out using the device according to the invention is significantly higher than that of the method according to the comparative example. Therefore, more detailed analyses of the course of the temperature-programmed reduction, especially in the catalyst characterization, can be carried out using the device according to the invention than when using the device of the comparative example. Therein, the device according to the invention furthermore has the advantage of a simpler construction, especially as it does not comprise a cooling trap.

### Example 5

### Characterization of Catalysts by Measurement of the Desorption of NH₃

The device used in example 3 was additionally provided with a second catalyst unit which was arranged between the reactor and the catalyst unit coupled to the supply unit for CO and/or CO₂. The reactor was charged with an alumino-silicate catalyst loaded with NH₃. The reactor was heated in a programmed way and continuously swept with inert gas. The exiting NH₃-containing inert gas was fed into the second catalyst unit (Ni-catalyst, 700° C.) and then into the subsequently connected catalyst unit into which CO was continuously fed. The subsequently arranged FID detected signals which were measured each at the set temperature of the reactor for the desorption of NH₃, e.g. by means of a TCD. This example shows that using the device according to the invention which in addition to the conversion of hydrogen to methane in the catalyst unit also comprises the step of the generation of hydrogen from NH₃, e.g. in a second catalyst unit arranged upstream, and using the method carried out therewith, respectively, a detection of carbonless gaseous hydrogen compounds is possible using the FID.

### LIST OF REFERENCE NUMERALS

1 catalyst unit
2 inlet
3 FID
4 feed line
5 supply unit for CO and/or CO₂
6 separation column
7 injection device
8 bypass
9 valve
10 reactor
11 cooling trap
12 source for hydrogen-containing gas

1. Device for the detection of hydrogen in a gas mixture, characterized by a catalyst unit (1) having an inlet (2) for the gas mixture which catalyst unit (1) is connected to a supply unit (5) for continuous feeding of CO and/or CO₂ into the catalyst unit (1) and which catalyst unit (1) is connected to a flame ionization detector (3) by a feed line (4).

2. Device according to claim 1, characterized in that the device consists of a catalyst unit (1) having an inlet (2) for the was mixture, a supply unit (5) connected to the catalyst unit for continuous feeding of CO and/or CO₂ into the catalyst unit (1) and at flame ionization detector (3) which is connected to the catalyst unit (1) by a feed line (4).

3. Device according to claim 1, characterized in that the catalyst unit (1) has a metal-containing catalyst for conversion of hydrogen and CO and/or CO₂ as well as a thermostatting device for thermostatting the catalyst to 100 to 450° C.

4. Device according to claim 1, characterized in that a separation column (6) having an injection device (7) is connected to the inlet (2).

5. Device according to claim 1, characterized in that a connectable source for inert carrier gas is connected to the inlet (2) or to the injection device (7), providing carrier gas for transport of the gas mixture into the catalyst unit (1).

6. Device for the temperature-programmed reduction of mixtures containing a metal oxide, characterized by a device according to claim 1, and characterized in that to heatable reactor (10) is connected to the inlet of the catalyst unit (1) by a duet, wherein the reactor (10) is connected to a source (12) of hydrogen-containing gas from which the reactor (10) can continuously be streamed through by hydrogen-containing gas.

7. Device according to claim 6, characterized in that between the reactor (10) and the flame ionization detector (3) no device for separation of a component of a gas mixture is arranged, especially no cooling trap (11).

8. Device according to claim 6, characterized in that in addition a second catalyst unit is connected to the inlet (2) of the catalyst unit (1) for passage of the gas mixture, wherein the second catalyst unit contains a catalyst which decomposes a carbonless hydrogen compound to hydrogen.

9. Device according to claim 8, characterized in that the second catalyst unit is a capillary connected to the inlet (2) of the catalyst unit (1) which capillary is filled or coated on its inner side with a catalyst.

10. Use of a device according to claim 6 as detection device of a reduction device for catalyst characterization.

11. Method for the detection of hydrogen in a hydrogen-containing gas mixture, characterized by the conversion of the hydrogen-containing gas mixture in a catalyst unit (1) to which CO and/or CO₂ is continuously fed, wherein the gas mixture exiting from the catalyst unit (1) is fed into a flame ionization detector (3) operated with a hydrogen-containing fuel gas.

12. Method according to claim 11, characterized in that the hydrogen-containing gas mixture is fed into the catalyst unit (1) in a continuous flow of an inert carrier gas.

13. Method according to claim 11, characterized in that the catalyst in the catalyst unit (1) is thermostatted to 100 to 450° C.

14. Method according to claim 11, characterized in that the hydrogen-containing gas mixture is conducted from a reactor (10) in which a metal oxide-containing mixture is arranged, and in that a mixture of hydrogen and inert gas is continuously fed from a source (12) into the reactor (10), while the reactor (10) is heated up.

15. Method according to claim 11, characterized in that water which is contained in a gas is not removed by condensation or freezing out.

16. Method according to claim 11, characterized in that the hydrogen-containing gas mixture is generated by catalytic decomposition of a gas mixture containing a gaseous hydrogen compound.

17. Method according to claim 16, characterized in that the gaseous hydrogen compound is NH₃, hydrazine, hydroxylamine or HCN.
